(19) United States
(12) Patent Application Publication
(10) Pub. No.: US 2015/0219008 A1
(43) Pub. Date: Aug. 6, 2015

(54) Compact Sailplane Engine

(71) Applicant: Ernst Hunkeler, Cave Creek, AZ (US)

(72) Inventor: Ernst Hunkeler, Cave Creek, AZ (US)

(21) Appl. No.: 14/665,058

(22) Filed: Mar. 23, 2015

(51) Int. Cl. F02B 33/08; F02B 61/00; F02P 1/04; F02B 75/02; F02B 39/04

(52) U.S. Cl. CPC F02B 33/08; F02B 75/02; F02B 39/04; F02P 1/04; F02B 61/00; F02B 2075/025

(57) ABSTRACT

An engine adapted for installation within a sailplane, comprising: a charger assembly a charger cylinder comprising: a inlet port for receiving fuel mixture; and an outlet port; and a charger piston reciprocally disposed within the charger cylinder such that, the charger piston is movable between top and bottom positions, the charger cylinder to receive the fuel mixture there within when the charger piston is at the top position, the fuel mixture to egress through the outlet port as the charger piston slides to the bottom position.

### CROSS-REFERENCE TO RELATED APPLICATIONS

The Invention relates to a single cycle supercharged retractable combustion sailplane engine.

### BACKGROUND OF THE INVENTION

1.) The compact and slim profile of this engine is key to the invention.

2.) Low installation weight.

3.) Imperceptible vibration transmission.

4.) Low exhaust noise and no gear noise.

5.) Full power start from a cold engine.

6.) Single carburetor.

7.) Conventional manufacturing methods and procedures can be used for manufacturing this engine.

### BRIEF SUMMARY OF THE DRAWINGS

FIG. 1 is a vertical section of the engine showing all essential components.

FIG. 2 is a cross section through the inlet and exhaust ports of the power cylinder

FIG. 3 is a cross section of the exhaust pressure control valve.

FIG. 4 is an electrical wiring diagram of the Ignition system.

FIG. 5 represents a force diagram illustrating the load against the upper connecting rod bearing during the upstroke of the power piston AT 3000 RPM.

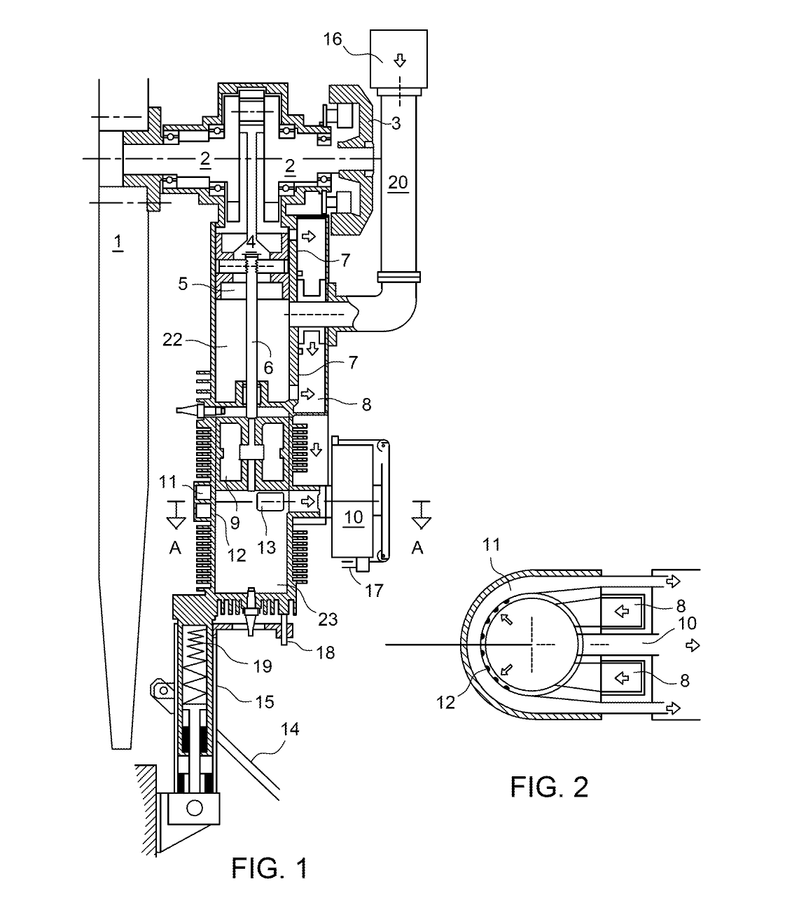

### SUMMARY OF THE INVENTION. (FIG. 1)

The engine is a single cycle or one stroke engine because it delivers power with every stroke.

It is intended to power a single seat sailplane.

Engine Power: 42 HP

Max. speed with Prop 55 in×40 in: 2550 rpm static at about 70% throttle opening.

Engine weight 51 lb (23 kg) ¹)

Piston stroke 4 inch

Power Piston Diameter 3.05 inch

Power pistons displacement 58.45 in³ (958 cm³)

Effective power piston displacement 42.3 in³ (693 cm³)

Displacement ratio 0.72:1 ²)

Effective charge piston displacement 72 in²

Width of engine 7 inch (178 mm)

Supercharge 1.5 psi.

Vertical oscillation due to moving piston mass 0.127 inch

¹) Included in this weight are electric start, carburetor, engine mount and wood propeller.

²) This value is much greater in the COMPACT than is found for conventional 2 stroke engines.

The inlet ports can be made smaller because the engine runs at less than halve the speed of conventional engines. Small exhaust ports are arranged around the periphery of the cylinder in addition to the main exhaust port FIG. 1. This outlet design is needed to prevent hour glass distortion of the cylinder due to temperature differences caused by the incoming fuel mixture which has a strong cooling effect on the center portion of the cylinder.

### How it Works.

The following description can be understood by any person skilled in the art and science of internal combustion engines and specifically of 2 stroke engines.

The engine works like a two stroke engine except for the supercharge, the double acting pistons and the ram tube FIG. 1.

The upper piston 5 which is the charge piston sucks the gas mixture through the carburetor 16 down the ram tube 20 into the charge cylinder 22. On the return stroke the mixture is delivered over the reed valve 7 into the plenum box 8. An opening on the bottom of the plenum box connects with the inlet ports 13 to the power cylinder 23. When the power piston 9 opens the inlet port 13 near the end of the piston stroke pressurized mixture enters the power cylinder and displaces the exhaust gases with a fresh charge. On the return stroke the mixture is compressed and ignited by sparkplug. This part of the cycle and the power transfer by the connecting rod 4 and crankshaft 2 is the same as in any combustion engine FIG. 1: 1,2,3,4. This can be understood by any person skilled in the art and science of internal combustion engines without any further description.

### PRIOR ART

A professional patent search has not uncovered a similar devise using the operating principle of the COMPACT. Prior sailplane engines are adaptations of standard 2 stroke engines used primarily in recreational applications. (Snow mobiles, outboard motors etc.)

### DETAILED DESCRIPTION OF THE INVENTION

The invention relates to a two cylinder engine FIG. 1 with the cylinders in tandem arranged concentrically instead of side by side as is common in conventional engines. One cylinder and piston comprising a double acting charge pump the other cylinder and piston a double acting power plant. The pistons are rigidly connected by a piston rod 6.

The engine can fit into a slender sailplane fuselage though a 7+inch wide door.

The power piston does not carry any side load (connecting rod force component) permitting a larger piston clearance. The benefit of this design is that the engine can run at full power right from the start without the need of a warm-up run. This feature will be appreciated by sailplane pilots when the ground is coming up fast and power is needed right now.

### Supercharge.

Super charge is achieved by the charge piston which has a larger displacement than the power piston. A second means of super charging is provided by the inlet ram tube. The ram tube provides over 120 in lb of kinetic gas energy at full throttle resulting from the near full vacuum of the rising charge piston. Full throttle is used only for takeoff. It provides added internal cooling by the excessive gas “washing” through the cylinders.

The charge piston down stroke also delivers excessive volume (40%) for the same purpose. It is effective for the down stroke of the power piston, whereas the ram tube delivers the largest volume for the upstroke of the power piston. This makes an almost balanced power output for both upstroke and down stroke. A smooth near sinusoidal oscillation of the engine requires that both cylinders operate at about the same output level and the center of gravity of the engine be approximately at the piston center. Ram tubes have very limited effect in standard two stroke engines mainly because the exhaust is always open to atmospheric pressure.

### Reed Valves.

The reed valves have been designed to work at a much lower stress level than in conventional 2 stroke engines. The valve opening stretches over the width of the plenum box and therefore provides large gas passage even though the valve travel is a mere 0.25 inch and resulting in a gas velocity of less than 90 ft/sec.

The Valve is a 5 layer Kevlar composite 3.0×5.4×0.016 inch. 70% Kevlar fabric 30% epoxy by volume.

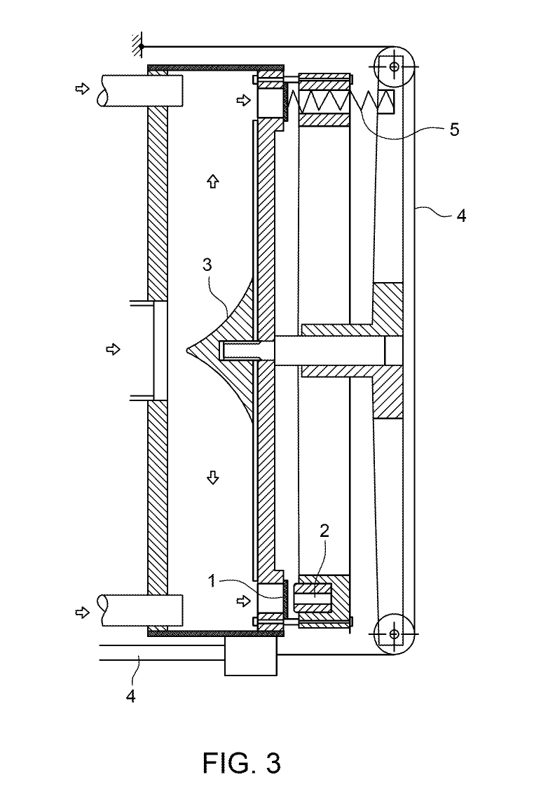

### Exhaust System FIG. 3.

The pressure control valve in the exhaust system 1 FIG. 3 controls the supercharge pressure. This valve is designed to open a very large gas passage (0.18 in×37 in) with only a small movement of the valve plate (0.18 in). This small movement permits the valve 1, FIG. 3 to open and close very rapidly. Response time of the valve can be calculated using FORMULA 2. The valve is designed to close in less than 40° of crank shaft rotation. (about 2 millisecond)

The total force of the springs 5 are determining the supercharge pressure which is adjustable by the pilot using a control cable 4. Instead of making the spring load adjustable, it may be preferable to set the spring load to a fixed value and install a mixture control on the carburetor, to insure a smooth low speed operation. The engine tends to runs lean at low speed under supercharge. Gas deflector 3 prevents turbulent gas flow. The weight of the valve ring and the volume of the exhaust box can be fine-tuned for best power output and minimum exhaust noise. Valve: Titanium sheet 6.25×5.2×0.032 inch. Weight: 0.7 oz. Exhaust box: 6.5 inch diameter, 1.75 inch long. Spring rate (total) 4.8 lb/inch

### Exhaust Noise.

The exhaust valve is still shut at the instant when the cylinder exhaust ports open. This traps much of the exhaust noise in the closed exhaust system before the gas flow opens the exhaust valve. This provides considerable noise reduction and produces a much lower tone (lower frequency) than a high speed 2 stroke engine. The gas exits at a relatively low speed through the long narrow slot in opposite directions from under the valve plate and this may also have a beneficial effect on the noise.

### Power Piston.

4 Piston rings are installed at both ends of the piston for heat transfer. Both ends are capped with an S. St. plate 0.040 in thick held in place with 6 Aluminum rivets.

### Dynamic Forces.

Because the oscillating mass of the piston assembly is considerably greater than in a conventional engine, the consequence is higher dynamic forces (acceleration) of the moving parts. The resulting mechanical forces on the drive mechanism however benefit from this fact since the accelerating forces always work in the opposite direction to the gas forces on both ends of the piston stroke. The resulting up-stroke force especially is considerably lower by this arrangement as shown on the force diagram FIG.5. Bearing loads drop with increasing engine speed and are cut in half at about 3000 rpm as shown in FIG. 5. F(a) represent the gas force and P(a) represents the combined effect of the gas force and the accelerating force and is the actual load on the upper connecting rod bearing. The heavy weight of the piston assembly causes a near sinusoidal change in the load on the engine mount spring. (3.15 lb) All other vibration whether from the engine or the prop are at a frequency higher than the engine rpm and are therefore absorbed by the spring mount.

This telescoping mount greatly reduces the transmission of vibration into the air frame and is imperceptible at the pilot seat. The lower the spring rate the better the vibration insulation to the airframe. There is no danger of resonance even at idle speed. Resonance is an issue with most airplane engine installations. Formula 1 can be used to calculate engine oscillation and designing the spring mechanism.

### Cooling.

The location of the bottom cylinder and cylinder head is near the periphery of the propeller and therefore benefits from the strong turbulent cooling effect of the prop blades passing in front of the cylinder. The upper cylinder tends to run cooler than the bottom cylinder because of the cooling effect of the charge cylinder and the upper structure of the engine acting as a heat sink. The charge cylinder receives cooling from both inside and outside which aids in extracting heat from the cylinder head. Additional cooling can be effected by running the engine at full throttle. Full engine power is obtained at 70% throttle. At full throttle some fuel mixture is circulated though the cylinders providing additional cooling and reducing the possibility of overheating. This could be helpful when taking off from a soft field when it takes a long time to reach flying speed.

### Starting Circuit.

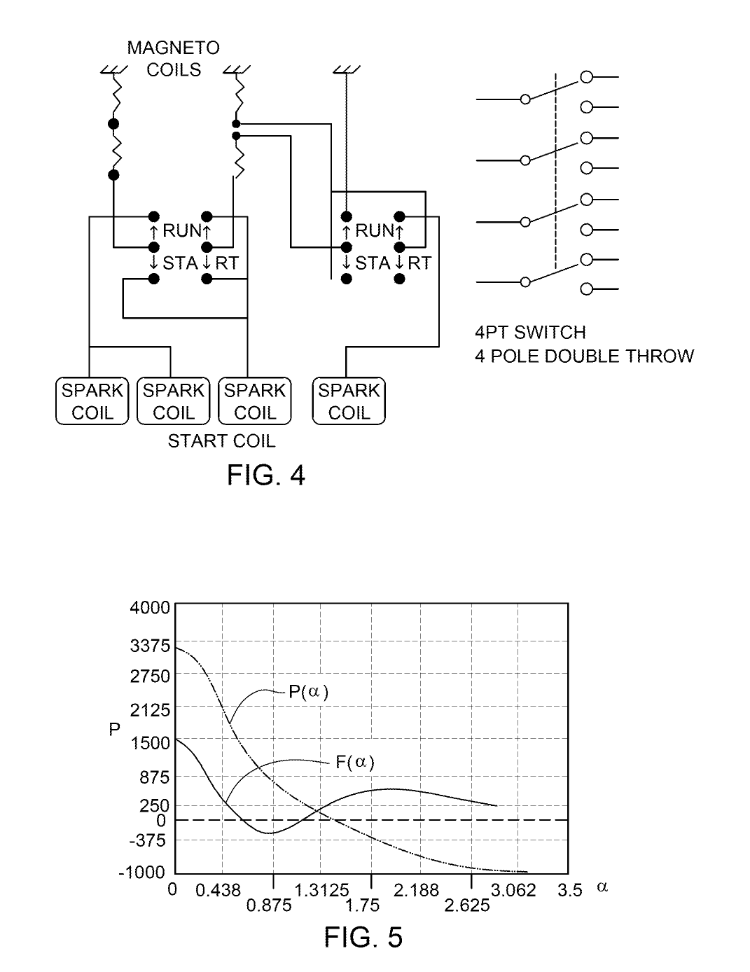

A considerable weight saving was achieved on the COMPACT by rewiring the standard ignition system according to FIG.4. It permits the use of a small starter motor and small starter battery. The 4 magneto coils are connected in series in the start position of the switch. This quadruples the power to the start sparkplug and lets the engine start at a much lower cranking speed.

### Formula 1

Vertical engine oscillation

$$X = \frac{{grb}^{2}}{1 - {b}^{2}} ( inch )$$

(0.127 inch at 2600 rpm)

q=piston weight/total weight minus piston weight [0.063]r=crank radius (half of piston stroke) [2 inch]

$$b = frequency ratio = \frac{n}{f} engine revolution per sec \text{/} natural frequency ( cycle per sec . ) ( 18.8 )$$

f=natural frequency (cycles/second)

$$f = \frac{1}{2 π} \sqrt{\frac{k}{m}} [ 2.3 \text{/} sec ]$$

m=engine mass

k=spring constant (lb/inch) [25 lb/in]

Total engine weight 50 lb

Piston assembly weight 3.15 lb

At high speed X≈qr. X=(0.126 inch)

At idle speed of 800 rpm X=0.13 inch

Oscillation force transmitted to the airframe Xk=[3.17 lb]

### Formula 2

Time required for closing the Exhaust Valve.

$$t = \sqrt{\frac{D \times W}{193 \times F}} [ t = \sqrt{\frac{.18 \times .044}{193 \times 12}} = .0018 seconds ]$$

t=time required to close the valve (sec);

W=weight of valve plate (lb);

F=average spring force (lb)

D=valve travel (in);
[W=0.04 lb; F=12 lb; D=0.18 inch ] [Titanium Valve plate]

What is claimed is:

1. An engine adapted for installation within a sailplane, the engine comprising:
(a) a charger assembly comprising:
(i) a charger cylinder comprising:
(1) a inlet port for receiving fuel mixture; and
(2) an outlet port; and
(ii) a charger piston reciprocally disposed within the charger cylinder such that, the charger piston is movable between top and bottom positions, the charger cylinder to receive the fuel mixture therewithin when the charger piston is at the top position, the fuel mixture to egress through the outlet port as the charger piston slides to the bottom position;
(b) a power assembly disposed below the charger assembly, the power assembly comprising:
(i) a power cylinder comprising:
(1) an inlet port for receiving pressurized fuel mixture; and
(2) an primary exhaust port for expelling exhaust gas, which is a result of the combustion of the pressurized fuel mixture within the power cylinder;
(ii) a power piston reciprocally disposed within the power cylinder such that, the power piston is movable between top and bottom positions, the power cylinder to receive the pressurized fuel mixture therewithin when the power piston is at the top position, the fuel mixture to egress through the primary exhaust ports as the power piston slides to the bottom position;
(c) a common piston rod for the charger and power pistons; and
(d) a crank shaft to which the piston rod is secured whereby, the rotary motion of the piston rod is imparted thereto.

2. The engine of claim 1 wherein, the fuel mixture is received from a carburetor.

3. The engine of claim 2 wherein, the carburetor comprises a smooth bore carburetor

4. The engine of claim 2 wherein, the fuel mixture is received from the carburetor via a ram tube.

5. The engine of claim 1 further comprising a plenum box within which, the fuel mixture from the outlet port of the charger cylinder is received, the plenum box for pressurizing the fuel mixture, the pressured fuel delivered into the power cylinder through the inlet port thereof.

6. The engine of claim 1 wherein, the power cylinder concentrically disposed with respect to the charger cylinder.

7. The engine of claim 1 wherein, the power cylinder further comprises a plurality of secondary exhaust ports through which, the exhaust gas is expelled.

8. The engine of claim 7 wherein, the plurality of secondary exhaust ports are disposed around the periphery of the power cylinder.

9. The engine of claim 7 wherein, the primary exhaust port is configured to shut at the instant the secondary exhaust ports are opened so as to trap much of the exhaust noise.

10. The engine of claim 1 wherein, the crank shaft is disposed in operative with the propeller whereby, the rotary motion thereof is imparted to the propeller.

11. The engine of claim 1 wherein, the displacement of the charger piston is larger than that of the power piston.

12. The engine of claim 1 further comprising a reed valve through which, the fuel mixture is received into the plenum box.

13. The engine of claim 1 wherein, the pressurized fuel mixture in the power cylinder is ignited by a spark plug.

14. The engine of claim 1 further comprising a pressure control valve that is configured to permit the exhaust of exhaust gas in the event of the pressure of the exhaust gas being in excess of a preset supercharge pressure.

15. The engine of claim 14 wherein, the control valve is configured to close in about 40 degrees of crank rotation.

16. The engine of claim 14 wherein, the supercharge pressure is adjustable.

17. The engine of claim 14 wherein, the control valve is spring-loaded.

18. The engine of claim 17 wherein, the pressure exerted by the spring is adjustable.

19. The engine of claim 1 wherein, the ignition thereof is facilitated by a plurality of magneto coils connected in series.

20. The engine of claim 19 wherein, the plurality of magneto coils comprises four magneto coils.
